(19) United States
(12) Patent Application Publication
(10) Pub. No.: US 2006/0067391 A1
(43) Pub. Date: Mar. 30, 2006

(54) Methods and systems for margin testing high-speed communication channels

(75) Inventor: Bruno Garlepp, San Jose, CA (US)

Correspondence Address: SILICON EDGE LAW GROUP, LLP, 6601 KOLL CENTER PARKWAY, SUITE 245, PLEASANTON, CA, 94566, US

(73) Assignee: Rambus Inc.

(21) Appl. No.: 10/956,307

(22) Filed: Sep. 30, 2004

(51) Int. Cl. H04B 17/00

(52) U.S. Cl. 375/224

(57) ABSTRACT

A receiver includes simple, effective margining circuitry to support manufacturer and in-situ margin testing of high-speed communication channels. The receiver includes an input pad coupled to a termination resistor and the input of a sampler. An internal or external current source alters the current through the termination resistor to vary the DC component of the input signal applied to the input of the sampler. The voltage margins of the receiver may be tested by monitoring the output of the sampler in response to a known data stream while adjusting the voltage on the input node of the sampler to determine the degree of voltage offset that can be tolerated without inducing receive errors.

### FIELD OF THE INVENTION

The present invention relates generally to the field of communications, and more particularly to high speed electronic signaling within and between integrated circuit devices.

### BACKGROUND

Integrated circuits (ICs) are the cornerstones of myriad computational systems, such as personal computers and communications networks. Purchasers of such systems have come to expect significant improvements in speed performance over time. IC and system designers push the performance boundaries in an attempt to meet this ever present demand. In conflict with the demand for speed performance, ICs and must convey information with an extremely high degree of reliability to be useful in e.g. computer-related applications. In an effort to optimize performance, manufacturers of ICs and the systems that employ them test their products to ensure they meet the competing demands for reliability and performance.

The production of errors on even infrequent occasions can cause serious problems in computer controlled operations and data processing. To complicate matters, error conditions are not static: changes in such variables as supply voltage and temperature can change a system's error sensitivity, as can changes in the noise environment. Also problematic, some forms of errors may only occur under particular circumstances, in response to particular patterns of data, for example. The vast number of combinations of performance-limiting conditions renders it difficult or impossible to perfect the speed performance of data communication systems, particularly those mass produced for use in diverse systems and environments.

Because a very fast but unreliable system is unacceptable, IC and system manufacturers design in error margins that take into account worst-case voltage and timing scenarios to ensure their designs meet advertised performance specifications. Unfortunately, the inclusion of unnecessarily large error margins means that those manufacturers will not be able to ship products at their full speed performance, which could cost them customers in an industry where speed performance is paramount. Thus, the goal of manufacturers is to keep margins small enough to provide adequate speed performance and large enough to guarantee a required or desired level of reliability.

The competing interests of speed and reliability render important the maintenance of margins that are small, for speed, but that are also always large enough for reliable communication. The ability to measure and characterize circuit margins is thus very important. In many cases it is desirable that ICs are tested first by the manufacturer and later in-situ. There is therefore a need for methods and circuits for margin testing high-speed communication channels within and between ICs and systems. Such methods and circuits would preferably facilitate in-situ testing without adversely impacting circuit performance, and would not occupy significant device area.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a receiver 100 adapted in accordance with one embodiment to include simple, effective margining circuitry to support manufacturer and in-situ margin testing of high-speed communication channels.

FIG. 2 is a waveform diagram 200 illustrating the effect of injecting a two-milliamp (2 mA) test current Itest1 into the non-inverting (+) input node of sampler 115 when termination resistor 120 has a value of fifty (50) Ohms.

FIG. 3 depicts a receiver 300 in accordance with another embodiment. Receiver 300 is a double data rate (DDR) receiver that samples incoming data RX+/RX− on alternating (odd and even) edges of a sample clock derived from the incoming data using integrated clock and data recovery circuitry.

FIG. 4 depicts a test circuit 400 illustrating the general case in which a current source 405 injects a test current Itest across a termination resistance Rterm to a low-impedance voltage node (e.g., ground).

FIG. 5 depicts a system 500 in accordance with an embodiment in which the termination resistors are coupled to a relatively high-impedance voltage source HighZ.

FIG. 6 depicts a current source 600 for use in some embodiments of the invention to inject at test current into one or the other of a pair of input nodes intRX+ and intRX−.

### DETAILED DESCRIPTION

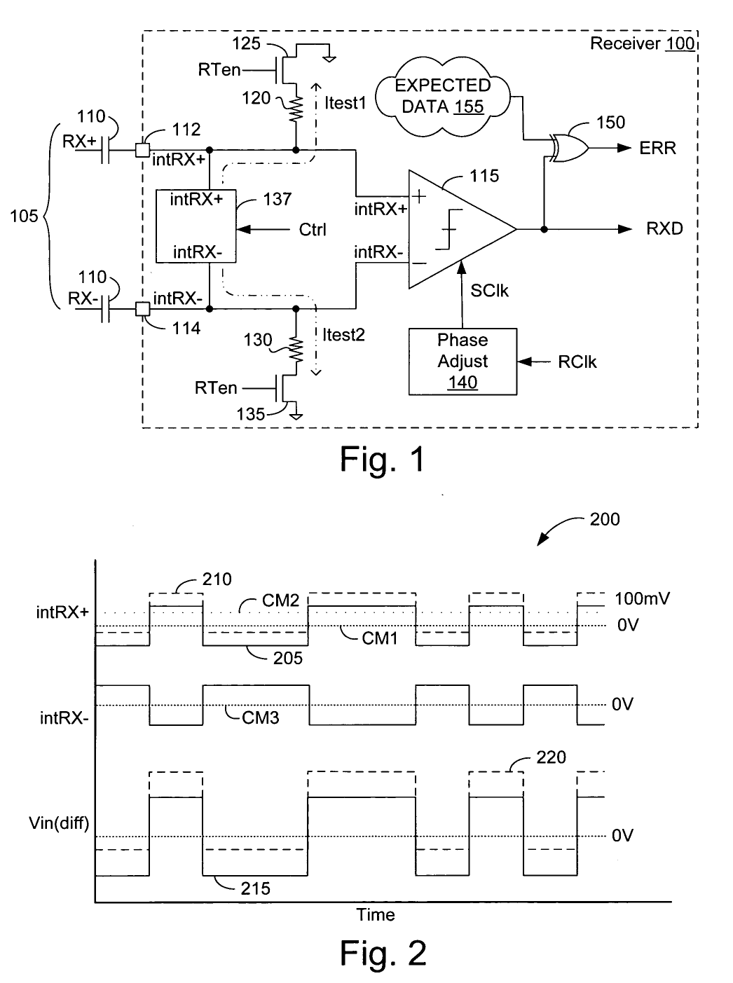

FIG. 1 depicts a receiver 100 adapted in accordance with one embodiment to include simple, effective margining circuitry to support manufacturer and in-situ margin testing of high-speed communication channels. In the present example, receiver 100 is a single channel serial receiver receiving a differential data signal RX+/RX− from an associated transmitter (not shown) via a communication channel 105. Receiver 100 is AC coupled to communication channel 105 via a pair of external capacitors 110 and the respective pair of input pads 112 and 114.

Receiver 100 includes a sampler 115 having a first data input node intRX+ coupled to pad 112 and a second input data node intRX− coupled to pad 114. A first termination resistor 120, or termination element, and transistor 125 selectively couple the first data node of sampler 115 to an adjustable or constant-voltage node when termination-enable signal RTen is asserted. In the embodiment of FIG. 1, the constant-voltage node is a constant voltage node at ground potential. A second termination element 130, a fixed-value termination resistor in this case, and transistor 135 selectively couple the second data node to a second adjustable or constant-voltage node (again ground potential in this embodiment) when signal RTen is asserted. Though not shown, sampler 115 can include or be preceded by a preamplifier.

In accordance with the depicted embodiment, receiver 100 includes a current source 137 that provides test currents Itest1 and Itest2 through respective ones of termination resistors 120 and 130 to vary the voltage on one or both input nodes of sampler 115. The voltage margins of receiver 100 may be tested by monitoring the output of sampler 115 in response to a known data stream while adjusting either or both of test currents Itest1 and Itest2, and consequently adjusting the voltage on the input node or nodes of sampler 115, to determine the degree of voltage offset that induces receive errors. Test currents Itest1 and Itest2 can be the same or different, can be derived from separate or a common current source, and can be applied separately or simultaneously.

Receiver 100 includes phase adjust circuitry 140 that develops a sample clock SCLK using a reference clock RCLK. Sampler 115 samples data signals received via channel 105 using sample clock SCLK to produce received data RXD. As discussed below in more detail, a comparison circuit 150 may be used to compare received data RXD with some source of expected data 155. Comparison circuit 150, an exclusive OR gate in this embodiment, develops an error signal ERR in response to mismatches between received and expected data. Current source 137 injects one or both of test currents Itest1 and Itest2 through respective termination resistors 120 and 130 to introduce a voltage offset or a pair of voltage offsets onto one or both input nodes of sampler 115. Any one or a combination of current source 137, termination resistors 120 and 130, transistors 125 and 130, expected data source 155, and comparison circuit 150 may be integrated with receiver 100.

Referring first to the non-inverting input node of receiver 100, capacitor 110 and the non-inverting input of sampler 115 present relatively high impedances to current from source 137; in contrast, the termination resistance provided by resistor 120, transistor 125, and the respective ground connection is relatively low impedance. Test current Itest1 injected by current source 137 onto the data node common to pad 112 and sampler 115 thus predominately flows through termination resistor 120 and transistor 125. The termination resistance is known, as is test current Itest1, so the voltage at the input of sampler 115 may be calculated by application of Ohm's law. A current control port CTRL to current source 137 receives current control signals that can vary test current Itest1 to vary the common-mode voltage experienced by the non-inverting input node of sampler 115. The inverting input node of receiver 100 may be tested in the same manner as the non-inverting input node using test current Itest2, which may be the same or operate over the same range as test current Itest1. The voltage margin of sampler 115 can be thus tested, as discussed below in connection with FIG. 2, by measuring the sensitivity of sampler 115 to voltage shifts on one or both data input nodes. In some embodiments, test currents Itest1 and Itest2 may be invariant, as where only a simple go/no-go margin test is sufficient, or to apply a systematic voltage offset or offset correction.

In some embodiments, the transmitted data signal on channel 105 uses a balanced transmission coding scheme, the well-known 8B 10B coding scheme for example, and the common-mode level of the complimentary signals presented on the data nodes of sampler 115 are normally kept at zero, or ground potential, by coupling termination resistors 120 and 130 to ground. Other embodiments may utilize different common voltage levels, as will be evident to those of skill in the art, e.g. by coupling resistors 120 and 130 to another voltage potential.

FIG. 2 is a waveform diagram 200 illustrating the effect of injecting a two-milliamp (2 mA) test current Itest1 into the non-inverting (+) input node of sampler 115 when the sum of the resistances of transistor 125 and termination resistor 120 equals fifty (50) Ohms. Termination resistor 120 is coupled to ground through transistor 125, so the non-inverting input to sampler 115 has a zero-volt DC component in the absence of any test current Itest. A first waveform 205 uses a solid line to depict a hypothetical data signal having a zero-volt common mode voltage CM1. When applied, test current Itest1 passes predominantly through termination resistor 120 to ground because capacitor 110 and the input node of sampler 115 exhibit relatively high impedances. Applying Ohm's law to the example in which test current Itest is 2 mA and the series resistance of resistor 120 and transistor 125 is 50 Ohms, the DC component of the voltage at the non-inverting input to sampler 115 is one hundred millivolts (100 mV). A second waveform 210 uses a dash line to depict the same data signal offset by 100 mV (i.e., the effective common-mode voltage CM2 is 100 mV) by passing a 2 mA test current Itest1 through resistor 120 and transistor 125.

Diagram 200 shows the intRX+/intRX− as complimentary signals. In the absence of any voltage offset, sampler 115 sees the combined signals intRX+ and intRX− as a differential signal 215 balanced around zero volts. A dashed line 220 illustrates the case where test current Itest1 through resistor 120 and transistor 125 offsets the voltage on node 112, and consequently changes the signal perceived by sampler 115. Some degree of voltage offset will cause sampler 115 to misinterpret the incoming data. The voltage margins of receiver 100 may thus be tested by monitoring the output of sampler 115 in response to a known data stream while adjusting one or both of test currents Itest1 and Itest2. Differences between the sampled and known data indicate sampling errors.

In some embodiments, current source 137 is a digital-to-analog converter (DAC), in which case control signal CTRL can be a digital signal that controls the levels of the test currents over a desired range, and consequently controls the level of offset voltage applied to one or both input nodes of sampler 115. The sensitivity of sampler 115 to input voltage offsets on the non-inverting input terminal can thus be characterized by monitoring received data RXD for errors while varying the voltage dropped across termination resistor 120. The process can be repeated for the inverting (−) terminal of sampler 115, if desired by passing test current Itest2 through resistor 130. In some embodiments, the offset voltages applied to both input nodes of sampler 115 can be altered simultaneously. The processes of margin testing the inverting input or both inputs simultaneously are similar to the process of margin testing the non-inverting input, so detailed descriptions are omitted for brevity.

Comparison circuit 150 is included to compare the output of sampler 115 with the data expected of sampler 115 (i.e., receive data RXD should be identical to the input data expressed differentially as RX+/RX−). Expected data 155 can be from any of a number of potential data sources that accurately reflect data signals received on pads 112 and 114. Such expected data sources can include, for example, an internal or external memory, a second sampler coupled to pads 112 and 114, or a bit-stream generator provided on or off a chip that provides the same data stream as received on pads 112 and 114. In one embodiment, expected data source 155 includes a linear-feedback shift register. Many options are available, as is well understood by those of skill in the art.

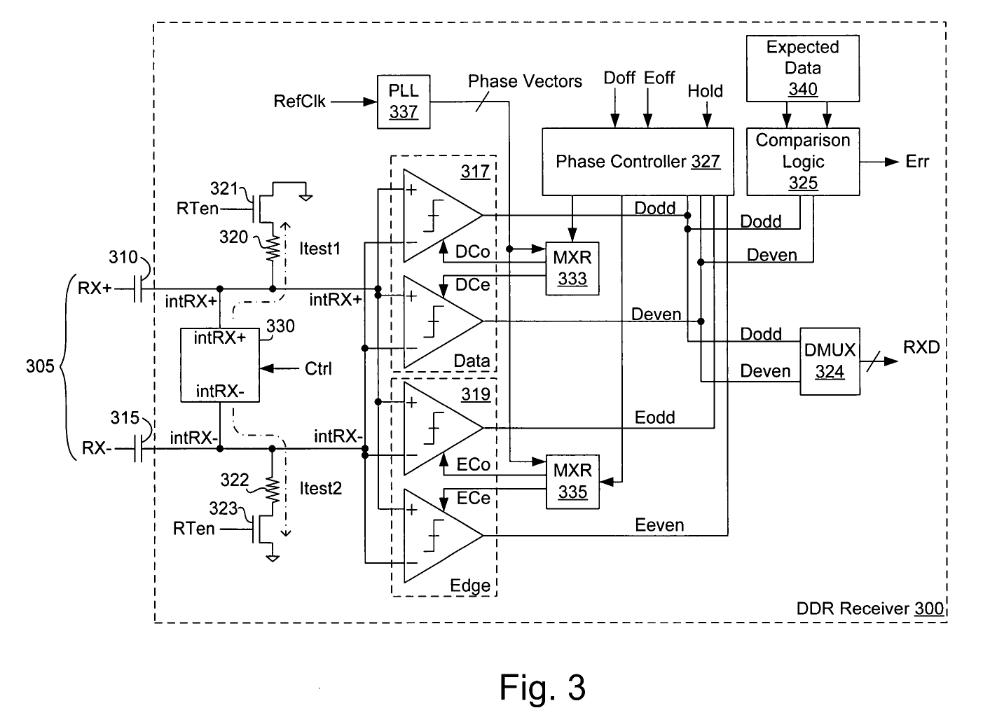

FIG. 3 depicts a receiver 300 in accordance with another embodiment. Receiver 300 is a double data rate (DDR) receiver that receives incoming data RX+/RX− and samples internal received data intRX+ and intRX− on alternating (odd and even) edges of a sample clock derived from the incoming data using integrated clock and data recovery circuitry. Like receiver 100 of FIG. 1, receiver 300 supports voltage margining tests using circuitry that injects test currents into the data input terminals to vary the differential input voltage perceived by the samplers.

Moving from left to right, receiver 300 receives input data RX+/RX− via a communication channel 305 and a pair of external capacitors 310 and 315. Capacitor 310 couples the first component RX+ to the non-inverting inputs of a pair of data samplers 317 and a pair of edge samplers 319, and capacitor 315 couples the second component RX− to the inverting inputs of samplers 317 and 319. A termination resistor 320 and transistor 321 couple the non-inverting inputs of the samplers to ground in response to an enable signal RTen. Termination resistor 322 and transistor 323 couple the inverting inputs of the samplers to ground in response to the same signal. In some embodiments, the enable signal RTen may be de-asserted, for example, in some power-down or low-power modes when the receiver is not operating. Other embodiments omit transistors 125 and 130. Current source 330 may be disabled during normal operation, or may be enabled to induce a voltage offset if desired.

Data samplers 317 sample respective odd and even data symbols (i.e., alternating data symbols arriving at receiver 300 in sync with the rising edges of the respective odd and even clock signals). The uppermost data sampler samples the odd data symbols using an odd-data clock DCo, while the lowermost data sampler of data samplers 317 samples the even data symbols using an even-data clock Eco. A demultiplexer 324 combines the odd and even data Dodd and Deven to produce parallel received data RXD. The odd and even data are also provided to some comparison logic 325, for error detection, and to a phase controller 327.

Edge samplers 319 operate as phase detectors that sample at the odd and even edges of the incoming data to develop an odd-edge signal Eodd and an even-edge signal Eeven, both of which are conveyed to phase controller 327. Phase controller 327 controls the sample timing of the received data symbols via a pair of phase mixers 333 and 335 (also called phase interpolators), which derive data and edge sampling clock signals by combining selected ones of a plurality of differently phased reference clocks, or “phase vectors,” from a phase-locked loop 337. In this DDR receiver, mixer 333 derives odd and even data clock signals DCo and DCe and mixer 335 derives odd and even edge clock signals ECo and ECe. These methods of recovering data and timing (clock) from an incoming signal are well known to those of skill in the art, obviating a need for a detailed discussion of the individual blocks.

Voltage margin tests for receiver 300 are performed in much the same way as described above in connection with FIGS. 1 and 2. A current source 330 injects a test current (Itest1 and/or Itest2) through one or both termination resistors 320 and 322 in response to a control signal Ctrl. Current source 330 is variable, in this embodiment, to provide a range of test currents in response to a range of digital control signals. Comparison logic 325 can be made to compare received data Dodd and Deven with some expected data to check for errors, and to issue an error signal Err in response to detected errors.

Altering one or both test currents changes the voltages on the inputs of the samplers, and consequently changes the sample point of all four samplers, including edge samplers 319. Changing the sample voltage of the edge samplers also changes the sample timing, so voltage margining can introduce jitter into the recovered clock signals DCo, DCe, Eco, and ECe. Thus, in some embodiments, phase controller 327 is adapted to hold a given phase relationship in response to an asserted hold signal Hold. To perform a voltage margin test, receiver 300 is allowed, in some embodiments, to recover the timing of the incoming data signal to produce a recovered clock signal, after which the timing is held while probing the voltage margins. Provided that the margin testing is performed over a relatively short time, holding the correct sample timing should not pose a problem, as circuit parameters that tend to cause the recovered clock signal to drift tend to occur over time periods that are long relative to signaling speeds (for example changes in temperature and the noise environment that usually do not happen instantaneously).

In some embodiments, phase controller 327 additionally supports timing margin tests. In the hold state (with signal Hold asserted), the data and edge clock signals can be phase adjusted using a pair of test control inputs Doff and Eoff. Receiver 300 can thus support tests of the timing margin as well as the voltage margin. The offset signals Doff and Eoff can be constants, as where pass/fail testing is sufficient, or can be varied over a range to perform more extensive margin testing.

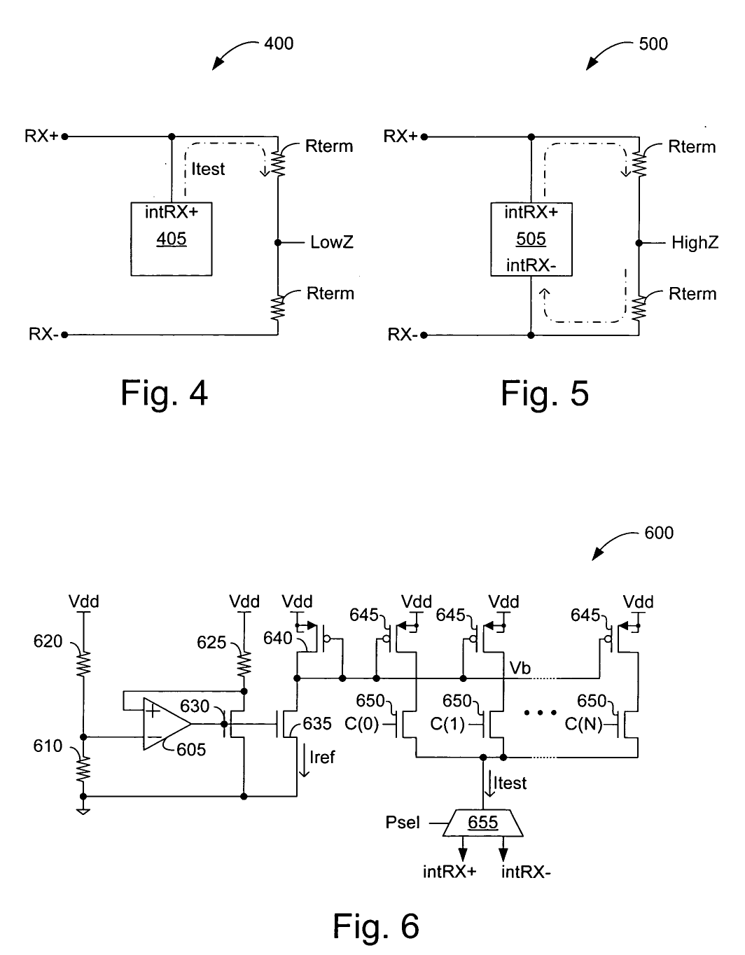

FIG. 4 depicts a test circuit 400 illustrating the general case in which a current source 405 injects a test current Itest across a termination resistance Rterm to a low-impedance voltage node (e.g., ground). Test circuit 400 can be incorporated into a receiver, such as those of the type described in connection with FIGS. 1 and 3. Due to the low-impedance reference LowZ, the voltage dropped across the termination resistor is simply the product of the values of the test current and termination resistance. The offset voltage at terminal intRX+ (or intRX−) is thus well characterized for test currents passing through either termination resistor. If the voltage node were of higher impedance, however, some portion of the voltage developed on terminal intRX+ (or intRX−) in response to a test current would be due to the impedance of the voltage node. Such a system would be more difficult to characterize, as the relationship between the voltage at terminal intRX+ (or intRX−) is not merely a product of the test current and termination resistance.

FIG. 5 depicts a system 500 in accordance with an embodiment in which the termination resistors may be coupled to a relatively high-impedance voltage source HighZ. Test circuit 500 can be incorporated into a receiver, such as those of the type described in connection with FIGS. 1 and 3, and is particularly useful when termination resistors are coupled to relatively high impedance nodes. A current source 505 extending between terminals intRX+ and intRX− forms a loop that passes that same current Itest through two termination resistors Rterm in series. The identity of the currents passing into and out of the high-impedance node HighZ means that no current passes through the high-impedance node, so the impedance of the voltage node has little or no impact on the voltage offset induced by the test current. System 500 can also be used to margin test receivers that employ low-impedance voltage nodes. System 500 injects a differential voltage offset across the two termination resistors Rterm.

FIG. 6 depicts a current source 600 for use in some embodiments of the invention to inject at test current into one or the other of a pair of input nodes intRX+ and intRX−. Current source 600 can be used, for example, as current source 137 of FIG. 1 or current source 330 of FIG. 3.

Current source 600 includes an operational amplifier 605, the inverting input terminal of which is coupled to ground potential and supply node Vdd by respective resistors 610 and 620. The non-inverting input of amplifier 605 is coupled to Vdd and ground via a resistor 625 and transistor 630, respectively. The output of amplifier 605 controls the current flow through transistor 630 and a parallel transistor 635. The voltage value of Vdd, the resistance value of resistor 625, the ratio of the resistance values of resistors 610 and 620, and the ratio of the sizes of transistors 630 and 635 thus determine a reference current Iref through transistor 635.

Current source 600 mirrors reference current Iref N+1 times using a current mirror that includes a first PMOS transistor 640 coupled in series with transistor 635, and thus passing current Iref, and N+1 additional PMOS transistors 645. The gates of transistors 645 are connected to the gate of transistor 640, so reference current Iref establishes the gate voltage applied to each transistor 645. PMOS transistors 645 collectively pass test current Itest. In some embodiments, transistors 645 have similar lengths and binary-weighted widths, so current source 600 can produce a wide range of currents by enabling selected ones of N+1 transistors 650. An N+1 bit control signal (e.g., signal Ctrl of FIG. 1) applied bitwise to control terminals C(0) to C(N) can thus be used to vary test current Itest over a desired range. A demultiplexer 655 responds to a select signal Psel by steering the test current to a selected one of nodes intRX+ and intRX−. In other embodiments, transistors 645 are of the same width and the control signal is thermometer coded.

The margining circuits and techniques described herein are simple and easily integrated. The current sources used in some embodiments are provided externally (e.g. an external current source is coupled to one or both of pads 112 and 114 of FIG. 1). Similarly, the voltage offset introduced on pads 112 and 114 can be monitored directly using external test equipment. Where the termination resistance or test current is not well characterized, the termination resistance, test current, or both can be calibrated. For example, the value of termination resistor 120 can be calibrated to 50 Ohms by adjusting the value of resistor 120 while applying a 100 mA current to pad 112 until the voltage at pad 112 is 5V. Though not shown, some such embodiments include digitally controlled termination resistors, many varieties of which are well known in the art. In some embodiments the voltage margining circuitry may be used to correct a systematic offset voltage of the corresponding sampler or samplers.

In the foregoing description and in the accompanying drawings, specific terminology and drawing symbols are set forth to provide a thorough understanding of the present invention. In some instances, the terminology and symbols may imply specific details that are not required to practice the invention. For example, the interconnection between circuit elements or circuit blocks may be shown or described as multi-conductor or single-conductor signal lines. Each of the multi-conductor signal lines may alternatively be single-conductor signal lines, and each of the single-conductor signal lines may alternatively be multi-conductor signal lines. Signals and signaling paths shown or described as being single-ended may also be differential, and vice-versa. Similarly, signals described or depicted as having active-high or active-low logic levels may have opposite logic levels in alternative embodiments. As another example, circuits described or depicted as including metal oxide semiconductor (MOS) transistors may alternatively be implemented using bipolar technology or any other technology in which a signal-controlled current flow may be achieved. With respect to terminology, a signal is said to be “asserted” when the signal is driven to a low or high logic state (or charged to a high logic state or discharged to a low logic state) to indicate a particular condition. Conversely, a signal is said to be “de-asserted” to indicate that the signal is driven (or charged or discharged) to a state other than the asserted state (including a high or low logic state, or the floating state that may occur when the signal driving circuit is transitioned to a high impedance condition, such as an open drain or open collector condition). A signal driving circuit is said to “output” a signal to a signal receiving circuit when the signal driving circuit asserts (or de-asserts, if explicitly stated or indicated by context) the signal on a signal line coupled between the signal driving and signal receiving circuits. A signal line is said to be “activated” when a signal is asserted on the signal line, and “deactivated” when the signal is de-asserted. In any case, whether a given signal is an active low or an active high will be evident to those of skill in the art.

The output of the design process for an integrated circuit may include a computer-readable medium, such as, for example, a computer disk or a magnetic tape, encoded with data structures defining the circuitry that can be physically instantiated as in integrated circuit. These data structures are commonly written in Caltech Intermediate Format (CIF) or GDSII, a proprietary binary format. Those of skill in the art of mask preparation can develop such data structures from schematic diagrams of the type detailed above.

While the present invention has been described in connection with specific embodiments, variations of these embodiments will be obvious to those of ordinary skill in the art. For example:
1. The margining circuits and methods can be applied to receivers coupled to transmitters via DC channels. In that case, the test current would flow through termination resistors on both ends of the channel and the resulting test voltage would be affected by both.
2. The current sources employed to induce voltage offsets for margin testing can be simplified to offer but one setting, to provide for a coarse go/no-go margin test, for example.
3. Termination elements and test currents can be derived from calibrated resistances, voltages, and currents for more precise margin testing.
4. Embodiments of the invention may be adapted for use with multi-pulse-amplitude-modulated (multi-PAM) signals.
5. Integrated circuits adapted in accordance with some embodiments can store error data correlated to sample clock phase and the degree of voltage offset. Such data can be used to characterize receiver input characteristics, in generating a shmoo plot, for example.
6. Multiple receivers (e.g. of the type shown in FIG. 1) can be ganged together to function in parallel. Groups of receivers thus combined can share a current source for inducing voltage offsets, or a collection of current sources can share common control lines.
7. While applied above to differential input channels, embodiments of the invention can be applied to single-ended channels.
   Moreover, some components are shown directly connected to one another while others are shown connected via intermediate components. In each instance the method of interconnection, or “coupling,” establishes some desired electrical communication between two or more circuit nodes, or terminals. Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. Section 112.

What is claimed is:

1. A receiver comprising:
a. a first node adapted to receive a transmitted data signal;
b. a second node adapted to receive a voltage;
c. a termination element coupled between the first and second nodes, the termination element exhibiting a resistance; and
d. a current source having:
i. a current-source node coupled to the first node; and
ii. a current-control port adapted to receive a range of current-control signals;
iii. wherein the current source is adapted to pass a range of test currents through the termination element in response to the range of current-control signals.

2. The receiver of claim 1, further comprising a sampler having a sampler input node coupled to the first node.

3. The receiver of claim 2, further comprising a second sampler having a second sampler input node coupled to the first node.

4. The receiver of claim 3, wherein the first and second samplers are adapted to sample the transmitted data signal on different phases of a receive clock signal.

5. The receiver of claim 2, wherein the sampler includes a sampler output node, the receiver further comprising a comparison circuit having a first comparison-circuit input node coupled to the sampler output node and a second comparison-circuit input node coupled to a source of expected data.

6. The receiver of claim 1, further comprising a third node adapted to receive a second transmitted data signal complementary to the first-mentioned transmitted data signal, a fourth node adapted to receive a second voltage, and a second termination element exhibiting a second resistance between the third node and the fourth node; and wherein the current source has a second current-source node coupled to the third node.

7. The receiver of claim 6, further comprising a sampler having complementary first and second sampler input nodes coupled to the first node and the third node, respectively.

8. The receiver of claim 7, the current source further including a second current-source node coupled to the third node and adapted to pass a second range of test currents through the second termination element.

9. The receiver of claim 8, wherein the second range of test currents is a function of the current-control signals.

10. A receiver comprising:
a. a first terminal adapted to receive a transmitted data signal;
b. a voltage node adapted to provide a voltage;
c. a sampler having a sampler input node coupled to the first terminal, wherein the sampler is adapted to sample a sampler input signal on the sampler input node;
d. a resistor coupled between the first terminal and the voltage node; and
e. means for sourcing a current through the resistor to generate an offset voltage; and
f. means for applying the offset voltage and the transmitted data signal onto the sampler input node to generate the sampler input signal.

11. The receiver of claim 10, wherein the means for sourcing a current comprises means for iteratively sourcing a plurality of currents through the resistor to generate a plurality of offset voltages and the means for applying comprises means for iteratively applying the offset voltages, with the transmitted data signal, onto the sampler input node to generate a plurality of sampler input signals.

12. The receiver of claim 11, further comprising means for monitoring an output of the sampler for sample errors.

13. A margin-test method for a receiver having a receiver input node coupled to a voltage source via a termination element having a resistance, the test method comprising:
a. driving a first current through the termination element;
b. supplying, while driving the first current through the termination element, a first series of input data symbols to the input node of the receiver;
c. sampling the first series of input data symbols to produce a first series of sampled data symbols;
d. driving a second current through the termination element;
e. supplying, while driving the second current through the termination element, a second series of input data symbols to the input node of the receiver; and
f. sampling the second series of input data symbols to produce a second series of sampled data symbols.

14. The test method of claim 13, further comprising comparing the first series of input data symbols with the first series of sampled data symbols, and comparing the second series of input data symbols with the second series of sampled data symbols.

15. The test method of claim 14, wherein comparing the first series of input data symbols with the first series of sampled data symbols includes duplicating the first series of input data symbols to produce expected sampled data and comparing the expected sampled data with the first series of sampled data symbols.

16. The test method of claim 13, wherein the receiver includes a second input node coupled to a second voltage source via a second termination resistor, the method further comprising:
a. driving a third current through the second termination resistor;
b. supplying, while driving the third current through the second termination resistor, a third series of input data symbols to the first and second input nodes of the receiver; and
c. sampling the third series of input data symbols to produce a third series of sampled data symbols.

17. The test method of claim 16, further comprising:
a. driving a fourth current through the second termination resistor;
b. supplying, while driving the fourth current through the second termination resistor, a fourth series of input data symbols to the first and second input nodes of the receiver; and
c. sampling the fourth series of input data symbols to produce a fourth series of sampled data symbols.

18. A computer-readable medium having stored thereon information describing circuitry, the circuitry comprising:
a. a first node adapted to receive a transmitted data signal;
b. a second node adapted to receive a voltage signal;
c. a termination element having a resistance coupled between the first and second nodes;
d. a current source having a current-source node coupled to the first node; and
e. a sampler having a sampler input node coupled to the first node.

19. The medium of claim 18, wherein the circuit further comprises a third node adapted to receive a second transmitted data signal complementary to the first-mentioned transmitted data signal, a fourth node adapted to receive a second voltage, and a a second termination element having a resistance extending between the third node and the fourth node, wherein the sampler has a second sampler input node, complementary to the first sampler input node, and coupled to the third node.

20. The medium of claim 18, wherein the current source includes a current-control port adapted to receive a range of current-control signals.

21. The medium of claim 20, wherein the current source is adapted to pass a range of test currents through the termination element in response to the range of current-control signals.
